(19) United States
(12) Patent Application Publication
(10) Pub. No.: US 2025/0155624 A1
(43) Pub. Date: May 15, 2025

(54) RETARDATION OPTICAL ELEMENT AND METHOD OF MANUFACTURING RETARDATION OPTICAL ELEMENT

(71) Applicant: CANON KABUSHIKI KAISHA, Tokyo (JP)

(72) Inventors: KOUICHI YONETANI, Kanagawa (JP); KUMIKO YASHIMA, Tokyo (JP)

(21) Appl. No.: 18/934,636

(22) Filed: Nov. 1, 2024

(30) Foreign Application Priority Data
Nov. 13, 2023 (JP) 2023-193015

(51) Int. Cl. G02B 5/30

(52) U.S. Cl. CPC G02B 5/3083

(57) ABSTRACT

A retardation optical element includes: a substrate including a curved surface portion having a first width and a second width longer than the first width in a plan view in an optical axis direction; and a retardation film having a fast axis and a slow axis and attached to a curved surface of the curved surface portion, wherein an angle formed by the slow axis and the first width is smaller than 45° in the plan view.

### BACKGROUND OF THE INVENTION

### Field of the Invention

The present invention relates to a retardation optical element and a method of manufacturing a retardation optical element.

### Description of the Related Art

In recent years, head-mounted displays have been used in various fields such as virtual reality (VR), augmented reality (AR), mixed reality (MR), and the like. The head-mounted display has an optical system to form an image displayed on a display at the position of a user's eye. In the head-mounted display, a compact, lightweight optical system with high image quality is realized by folding an optical path using circularly polarized light and a half mirror. In addition, the head-mounted display needs avoiding the nose when worn by a user, and spaces for the installation of electronic devices such as motors, sensors, and the like need to be secured. For these reasons, the shape of an optical element used for the head-mounted display is not an axisymmetric circular shape like an optical element used for a digital camera, but a non-axisymmetric shape having a major diameter and a minor diameter at least one side of which is cut off in many cases. Further, it is known that the size and weight of the head-mounted display can be reduced by fabricating an element in which films having optical characteristics such as a polarizing film, a polarizing beam splitter (PBS) film, a retardation film, and the like are attached to a substrate having a curved surface, for example.

Japanese Patent Application Laid-Open No. 2012-220853 discloses an optical element in which a retardation film and the like are laminated and fixed by adhesives or the like.

However, in a retardation optical element in which a retardation film is attached to a substrate having a curved surface, such as the optical element disclosed in Japanese Patent Application Laid-Open No. 2012-220853, wrinkles occur in the film at the periphery of the retardation optical element, resulting in deterioration of the surface shape. In particular, in a retardation film manufactured by uniaxial stretching, the film stretching rate differs between in the direction of the fast axis and in the direction of the slow axis of the retardation film, and the film is more easily stretched in a direction parallel to the fast axis and less easily stretched in a direction parallel to the slow axis. Therefore, there is a problem that wrinkles of the film are generated in a direction crossing the slow axis such as a direction perpendicular to the slow axis of the retardation film in the peripheral part of the retardation optical element, and the surface shape is deteriorated.

### SUMMARY OF THE INVENTION

It is an object of the present invention to provide a retardation optical element and a method of manufacturing a retardation optical element that can suppress wrinkles of a retardation film even in the peripheral area of the retardation optical element.

According to one aspect of the present invention, there is provided a retardation optical element including: a substrate including a curved surface portion having a first width and a second width longer than the first width in a plan view in an optical axis direction; and a retardation film having a fast axis and a slow axis and attached to a curved surface of the curved surface portion, wherein an angle formed by the slow axis and the first width is smaller than 45° in the plan view.

According to another aspect of the present invention, there is provided a method of manufacturing a retardation optical element, the method including: arranging a substrate including a curved surface portion having a first width and a second width longer than the first width in a plan view viewed in an optical axis direction; and attaching a retardation film having a fast axis and a slow axis to a curved surface of the curved surface portion, while arranging the retardation film so that the angle formed by the slow axis and the first width is smaller than 45° in the plan view.

According to another aspect of the present invention, there is provided a method of manufacturing a retardation optical element, the method including: arranging a substrate including a curved surface portion; attaching a retardation film having a fast axis and a slow axis to a curved surface of the curved surface portion; and cutting off an end portion of the substrate including at least one side of the curved surface portion in a direction in which an angle with the slow axis becomes smaller than 45° in a plan view viewed in an optical axis direction.

Further features of the present invention will become apparent from the following description of exemplary embodiments with reference to the attached drawings.

### BRIEF DESCRIPTION OF THE DRAWINGS

FIG. 1 is a schematic diagram illustrating a retardation optical element according to a first embodiment of the present invention.

FIG. 2A is a schematic diagram illustrating a modification example of the substrate shape in the retardation optical element according to the first embodiment of the present invention.

FIG. 2B is a schematic diagram illustrating a modification example of the substrate shape in the retardation optical element according to the first embodiment of the present invention.

FIG. 2C is a schematic diagram illustrating a modification example of the substrate shape in the retardation optical element according to the first embodiment of the present invention.

FIG. 3A is a schematic diagram illustrating a method of manufacturing a retardation optical element according to the first embodiment of the present invention.

FIG. 3B is a schematic diagram illustrating the method of manufacturing the retardation optical element according to the first embodiment of the present invention.

FIG. 3C is a schematic diagram illustrating the method of manufacturing the retardation optical element according to the first embodiment of the present invention.

FIG. 3D is a schematic diagram illustrating the method of manufacturing the retardation optical element according to the first embodiment of the present invention.

FIG. 3E is a schematic diagram illustrating the method of manufacturing the retardation optical element according to the first embodiment of the present invention.

FIG. 3F is a schematic diagram illustrating the method of manufacturing the retardation optical element according to the first embodiment of the present invention.

FIG. 3G is a schematic diagram illustrating the method of manufacturing the retardation optical element according to the first embodiment of the present invention.

FIG. 3H is a schematic diagram illustrating the method of manufacturing the retardation optical element according to the first embodiment of the present invention.

FIG. 4A is a schematic diagram illustrating a substrate used for a retardation optical element of Example 1 of the present invention.

FIG. 4B is a schematic diagram illustrating a retardation film used for the retardation optical element of Example 1 of the present invention.

FIG. 4C is a schematic diagram illustrating a method of manufacturing the retardation optical element of Example 1 of the present invention.

FIG. 4D is a schematic diagram illustrating the method of manufacturing the retardation optical element of Example 1 of the present invention.

FIG. 4E is a schematic diagram illustrating the method of manufacturing the retardation optical element of Example 1 of the present invention.

FIG. 4F is a schematic diagram illustrating the method of manufacturing the retardation optical element of Example 1 of the present invention.

FIG. 4G is a schematic diagram illustrating the method of manufacturing the retardation optical element of Example 1 of the present invention.

FIG. 5A is a schematic diagram illustrating a substrate used for a retardation optical element of Example 8 of the present invention.

FIG. 5B is a schematic diagram illustrating a method of manufacturing a retardation optical element of Example 9 of the present invention.

FIG. 6A is a schematic diagram illustrating a substrate used for a retardation optical element of Example 10 of the present invention.

FIG. 6B is a schematic diagram illustrating a retardation film used for the retardation optical element of Example 10 of the present invention.

FIG. 6C is a schematic diagram illustrating a method of manufacturing the retardation optical element of Example 10 of the present invention.

FIG. 6D is a schematic diagram illustrating the method of manufacturing the retardation optical element of Example 10 of the present invention.

FIG. 6E is a schematic diagram illustrating the method of manufacturing the retardation optical element of Example 10 of the present invention.

FIG. 6F is a schematic diagram illustrating the method of manufacturing the retardation optical element of Example 10 of the present invention.

FIG. 6G is a schematic diagram illustrating the method of manufacturing the retardation optical element of Example 10 of the present invention.

FIG. 6H is a schematic diagram illustrating the method of manufacturing the retardation optical element of Example 10 of the present invention.

FIG. 7 is a schematic diagram illustrating a substrate used for a retardation optical element of Example 11 of the present invention.

FIG. 8A is a schematic diagram illustrating a display apparatus according to a second embodiment of the present invention.

FIG. 8B is a schematic diagram illustrating the display apparatus according to the second embodiment of the present invention.

FIG. 8C is a schematic diagram illustrating the display apparatus according to the second embodiment of the present invention.

### DESCRIPTION OF THE EMBODIMENTS

### First Embodiment

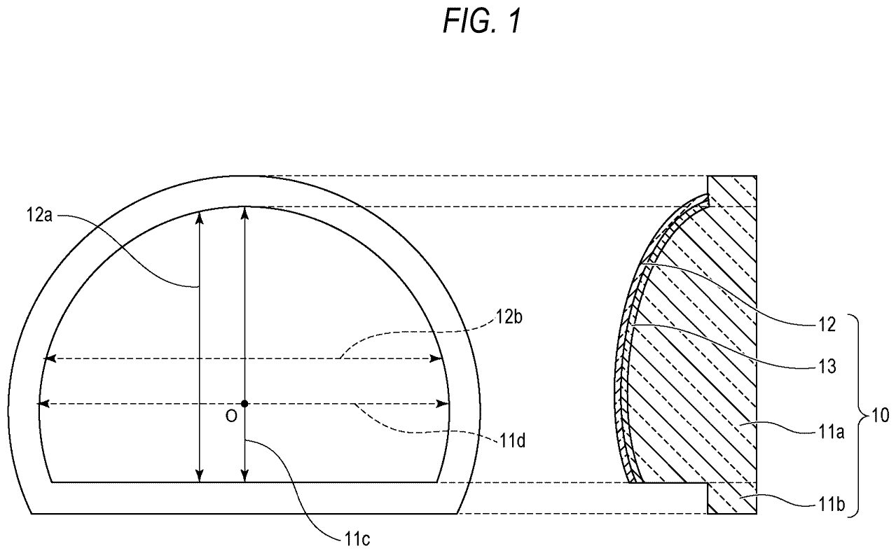

A retardation optical element and a method of manufacturing a retardation optical element according to a first embodiment of the present invention will be described with reference to FIG. 1 to FIG. 3H.

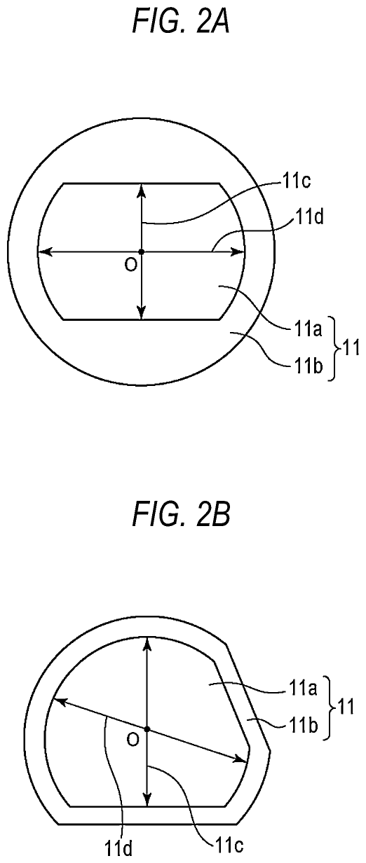

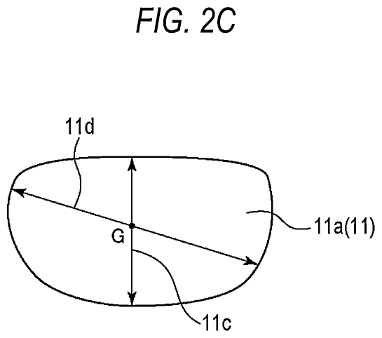

First, the retardation optical element according to the present embodiment will be described with reference to FIG. 1 to FIG. 2C. The retardation optical element according to the present embodiment is an optical element that has a function of providing a retardation or a phase difference between mutually orthogonal or intersecting polarized light components of light incident on the retardation optical element to make the polarized light components emit. By providing a retardation between the polarized light components, the retardation optical element can convert incident circularly polarized light into linearly polarized light, convert incident linearly polarized light into circularly polarized light, or change the polarization state of incident light.

FIG. 1 is a schematic diagram illustrating the retardation optical element 10 according to the present embodiment. In FIG. 1, the left figure is a plan view illustrating the retardation optical element 10 in a plan view viewed in the direction of light incident on the retardation optical element 10, and the right figure is a cross-sectional view illustrating a cross section of the retardation optical element 10 along a short diameter 11c described later.

As illustrated in FIG. 1, the retardation optical element 10 according to the present embodiment includes a substrate 11 and a retardation film 12. The substrate 11 includes a curved surface portion 11a positioned at the center and a peripheral edge portion 11b provided adjacent to the curved surface portion 11a at the peripheral edge of the curved surface portion 11a. The retardation film 12 is attached to the curved surface of the curved surface portion 11a.

The curved surface portion 11a has a non-axisymmetric shape in a plan view viewed in the optical axis direction of the substrate 11, and has a short diameter 11c and a long diameter 11d longer than the short diameter 11c. The optical axis direction of the substrate 11 is the optical axis direction of the retardation optical element 10, which is the direction in which light enters the retardation optical element 10. The short diameter 11c is the shortest diameter or width among the diameters or widths passing through the reference point of the shape of the substrate 11 in the plan view. The long diameter 11d is the longest diameter or width among the diameters or widths passing through the reference point of the shape of the substrate 11 in the plan view. More specifically, the curved surface portion 11a has a lacked circle shape which is a shape surrounded by an arc which is a part of the circumference of one circle and a line connecting both ends of the arc in a plan view viewed in the optical axis direction of the substrate 11. The line connecting both ends of the arc is, for example, a straight line, but may also be a curved line, a bent line, or the like. In this case, the short diameter 11c is the shortest diameter or width among the diameters or widths passing through the center point O of the circle of the arc of the curved surface portion 11a as the reference point in the plan view. The long diameter 11d is the longest diameter or width among the diameters or widths passing through the center point O of the circle of the arc of the curved surface portion 11a as the reference point in the plan view. The short diameter 11c and the long diameter 11d may not necessarily have to be orthogonal to each other.

The substrate 11 can function as a lens by the curved surface portion 11a. The curved surface to which the retardation film 12 is attached in the curved surface portion 11a has a convex or concave shape and may be spherical or aspherical. The surface of the curved surface portion 11a opposite to the curved surface to which the retardation film 12 is attached may be a flat surface, may be a curved surface of a convex or concave shape, and may be spherical or aspherical in the case of a curved surface.

The peripheral edge portion 11b is an optically ineffective region. For example, the peripheral edge portion 11b may be provided as a mold release margin when the substrate 11 is manufactured, especially when the substrate 11 is manufactured by injection molding, or may be provided for attaching to a housing of an optical apparatus such as a head-mounted display or the like. The peripheral edge portion 11b may be an axisymmetric shape or a non-axisymmetric shape regardless of having a curved surface or a flat surface. The peripheral edge portion 11b need not be provided over the entire circumference of the curved surface portion 11a, but may be provided over a part of the entire circumference of the curved surface portion 11a. In some cases, the peripheral edge portion 11b may not be provided.

Note that the shape of the substrate 11 in the plan view viewed in the optical axis direction of the substrate 11 is not limited to the shape illustrated in FIG. 1. FIG. 2A to FIG. 2C are plan views illustrating other examples of the shape of the substrate 11 in the plan view viewed in the optical axis direction of the substrate 11.

In the case of the substrate 11 illustrated in FIG. 2A, in the plan view, the curved surface portion 11a has a shape surrounded by two mutually opposed arcs and two mutually opposed parallel sides connecting two mutually opposed ends of these two arcs. The two arcs are parts of the circumference of the same circle. In this case, the substrate 11 has a peripheral edge portion 11b provided so as to have a circular shape in the plan view.

In the case of the substrate 11 illustrated in FIG. 2B, in the plan view, the curved surface portion 11a has a shape surrounded by two sides facing different directions and not opposite each other, and two arcs connecting two adjacent ends of these two sides. The two arcs are parts of the circumference of the same circle. In this case, the substrate 11 has a peripheral edge portion 11b provided in the same width around the outer periphery of the curved surface portion 11a in the plan view. Note that the curved surface portion 11a may have not only two sides but also three or more sides in the plan view. In this case, the curved surface portion 11a may have three or more arcs each of which is a part of the same circumference in the plan view, and two adjacent ends of two sides of the plurality of sides may be connected by the arc.

In the case illustrated in FIG. 2A and FIG. 2B, the short diameter 11c is the shortest diameter or width among the diameters or widths passing through the center point O of the circle of the arcs of the curved surface portion 11a in the plan view as the reference point. In these cases, the long diameter 11d is the longest diameter or width among the diameters or widths passing through the center point O of the circle of the arcs of the curved surface portion 11a in the plan view as the reference point.

In the case of the substrate 11 illustrated in FIG. 2C, in the plan view, the curved surface portion 11a has a shape such that the curved surface portion 11a has a plurality of arcs with different curvatures, for example, like a spectacle lens. In this case, the substrate 11 can be configured so as not to have the peripheral edge portion 11b. Further, in this case, the short diameter 11c is the shortest diameter or width among the diameters or widths passing through the center of gravity G of the shape of the curved surface portion 11a as the reference point in the plan view, and the long diameter 11d is the longest diameter or width among the diameters or widths passing through the center of gravity G of the shape of the curved surface portion 11a as the reference point in the plan view.

In an optical apparatus in which the retardation optical element 10 is used, especially in a head-mounted display, the size of the apparatus is limited because it is assumed to be worn on the face of a user, especially the eyes and nose. Therefore, in many cases, the shape of the substrate 11 is not an axisymmetric shape but a non-axisymmetric shape having a short diameter and a long diameter for the purpose of avoiding the nose of a user or securing spaces for installing electronic devices such as motors, sensors, and the like.

The material of the substrate 11 may be a transparent material, regardless of whether it is plastic or glass, having transparency against light such as visible light targeted by the retardation optical element 10. In the case of plastic, it is preferable to be molded by injection molding and used optically. Also, it is preferable that the material has a small birefringence. The value of the birefringence is preferably, for example, 30×10⁻⁵ or less. The value of the birefringence is more preferably, for example, 12×10⁻⁵ or less. Specifically, the plastic material of the substrate 11 is, for example, polycarbonate (PC), polyester (PEs), poly(methyl methacrylate) (PMMA), cyclo olefin polymer (COP), cyclic olefin copolymer (COC), or the like. In the case of glass, any material can be used, but synthetic quartz and BK-7 which is a common glass material, and the like are exemplified.

As illustrated in FIG. 1, the retardation film 12 is provided by being attached to the curved surface of the curved surface portion 11a of the substrate 11 by an adhesive layer 13. Although not particularly limited, the retardation film 12 is formed by stretching a film made of, for example, COP, COC, or PC in a certain direction. The retardation film 12 has a slow axis 12a and a fast axis 12b orthogonal to the slow axis 12a, and the phase of light incident in parallel to the slow axis 12a can be delayed by a specific wavelength to be emitted. The direction of the slow axis 12a and the direction of the fast axis 12b can be confirmed from the orientation angle calculated when birefringence measurement is performed, as an example. At this time, the direction in which the orientation angle is 0° is the direction of the fast axis 12b, and the direction orthogonal to the direction of the fast axis 12b is the direction of the slow axis 12a. The retardation film 12 has different film stretching rates between in the direction of the slow axis 12a and in the direction of the fast axis 12b and, in particular, the retardation film 12 is less likely to stretch in the direction of the slow axis 12a than in the direction of the fast axis 12b. The retardation film 12 is stretched as described later and is provided on the curved surface of the curved surface portion 11a.

Examples of the retardation film 12 include, but are not limited to, a ½ wavelength film, a ¼ wavelength film, and the like. The ½ wavelength film is a film that can delay the phase of light incident parallel to the slow axis 12a by a half of the wavelength. The ¼ wavelength film is a film that can delay the phase of light incident parallel to the slow axis 12a by a quarter of the wavelength.

Note that the retardation film 12 made of COP or COC is known to have a small birefringence variation with respect to the stretching of the film, but the adhesive strength with the adhesive layer 13 is weak and the adhesive strength with the substrate 11 is inferior. On the other hand, the retardation film 12 made of PC is known to have a large birefringence variation with respect to the stretching of the film, but the adhesive strength with the adhesive layer 13 is strong and the adhesive strength with the substrate 11 is excellent.

The retardation film 12 is attached to the substrate 11 so that the angle formed by the slow axis 12a and the short diameter 11c of the curved surface portion 11a is smaller than 45° in the plan view viewed in the optical axis direction of the substrate 11. Since the angle formed by the slow axis 12a and the short diameter 11c is small in this manner, when the retardation film 12 is attached to the substrate 11, the length of the curved surface portion 11a in the direction of the slow axis 12a in which the retardation film 12 is hardly stretched is shortened. Therefore, when the retardation film 12 is attached, even in the direction of the slow axis 12a in which the retardation film 12 is hardly stretched, the retardation film 12 is pushed out to be stretched and the wrinkles of the retardation film 12 is easily brought outside the curved surface portion 11a of the substrate 11. Thus, in the retardation optical element 10 according to the present embodiment, the wrinkles of the retardation film 12 in the curved surface portion 11a can be suppressed. From the viewpoint of further suppressing the wrinkles of the retardation film 12, it is preferable that the retardation film 12 is attached so that the angle formed by the slow axis 12a and the short diameter 11c of the curved surface portion 11a is within 30° in the plan view viewed in the optical axis direction of the substrate 11. More preferably, the retardation film 12 is attached to the substrate 11 so that the slow axis 12a and the short diameter 11c of the curved surface portion 11a are substantially parallel to each other in the plan view viewed in the optical axis direction of the substrate 11. The substantially parallel means that the angle formed by the slow axis 12a and the short diameter 11c of the curved surface portion 11a is in a range of +2°, which also includes 0°. When the angle formed by the slow axis 12a and the short diameter 11c is 45° or more, the length of the curved surface portion 11a in the direction of the slow axis 12a is not sufficiently short and thus the effect of suppressing the wrinkles cannot be expected.

Here, when the radius of curvature of the curved surface to which the retardation film 12 is attached in the curved surface portion 11a is R and the length of the long diameter 11d of the curved surface portion 11a is L2, the half open angle θ of the curved surface of the curved surface portion 11a is defined by the following expression 1. Note that, when the curved surface of the curved surface portion 11a is an aspheric surface, the radius of curvature R can be an optimum value, an approximate value, or the like obtained by an optimum fitting by a least squares method.

sinθ=(L2/2)/R (Expression 1)

Note that the half open angle θ may be appropriately set in accordance with the design of the substrate 11 that functions as a lens, but is preferably 0°<θ≤30° from the viewpoint of the substrate 11 that functions as a lens.

Further, note that, when the length of the short diameter 11c of the curved surface portion 11a is L1 and the angle formed by the slow axis 12a and the short diameter 11c is q, it is preferable that the length L1 of the short diameter 11c and the length L2 of the long diameter 11d satisfy the following expression 2 with respect to the range of the half open angle θ of 5°≤0≤30°.

0.2≤(L1/cosφ)/L2≤−0.01×θ+1.0(Expression2)

Expression 2 indicates that the larger the half open angle θ is, the more the retardation film 12 needs to be stretched to be attached, and in order to suppress the wrinkles of the retardation film 12, it is preferable to reduce the ratio of the length L1 of the short diameter 11c to the length L2 of the long diameter 11d. That is, Expression 2 indicates that the larger the half open angle θ is, the shorter the length L1 of the short diameter 11c is preferable.

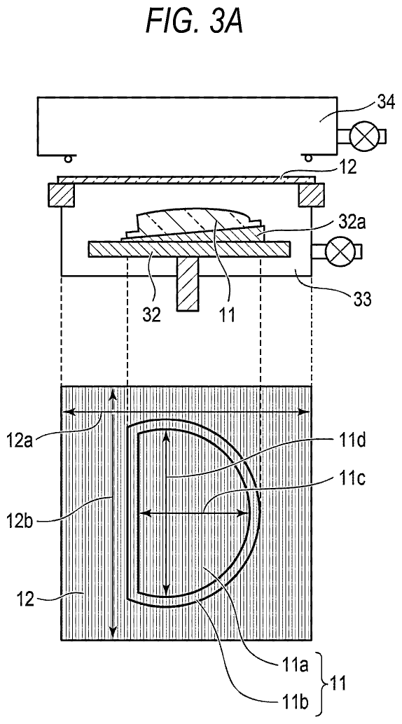

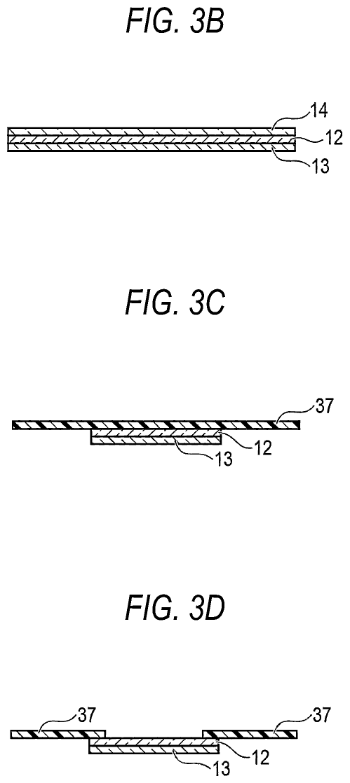

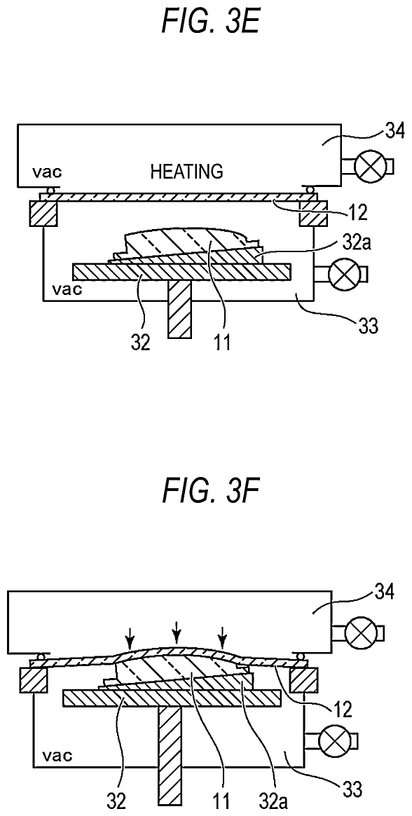

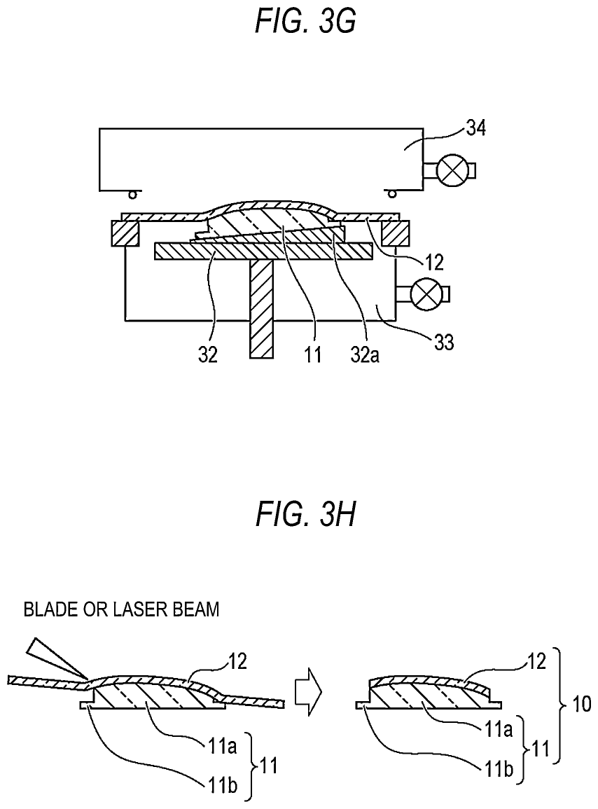

Next, a method of manufacturing the retardation optical element 10 according to the present embodiment will be described with reference to FIG. 3A to FIG. 3H. The upper figure of FIG. 3A and FIG. 3E to FIG. 3H are cross-sectional views illustrating the method of manufacturing the retardation optical element 10 according to the present embodiment. The lower figure of FIG. 3A is a plan view illustrating the substrate 11 and the retardation film 12 in the process illustrated in the upper figure of FIG. 3A, which is a plan view viewed in a direction perpendicular to the film surface of the retardation film 12. FIG. 3B to FIG. 3D are cross-sectional views illustrating examples of the form of the retardation film 12 when the retardation film 12 is attached to the substrate 11.

As illustrated in FIG. 3A, the substrate 11 having the short diameter 11c and the long diameter 11d is arranged to be prepared in a first chamber 33. The substrate 11 is arranged on a stage 32 having a rise and fall mechanism in the first chamber 33. A second chamber 34 is arranged above the first chamber 33. The upper part of the first chamber 33 and the lower part of the second chamber 34 are provided with mutually connectable openings. The retardation film 12 is arranged between the first chamber 33 and the second chamber 34 connected through these openings. At this time, the retardation film 12 is arranged so as to face the substrate 11. The uniform adhesive layer 13 (see FIG. 3B to FIG. 3D) is provided on the surface of the retardation film 12 on the side of the substrate 11.

In the arrangement described above, the retardation film 12 is arranged such that the angle formed by the short diameter 11c of the curved surface portion 11a of the substrate 11 and the slow axis 12a of the retardation film 12 is smaller than 45°, preferably within 30°, and more preferably the short diameter 11c and the slow axis 12a are substantially parallel to each other in a plan view viewed in the optical axis direction of the substrate 11. Thus, as will be described later, when the retardation film 12 is attached to the substrate 11, the length of the curved surface portion 11a in the direction of the slow axis 12a in which the retardation film 12 is less stretched becomes shorter. Thus, the wrinkles of the retardation film 12 can be easily pushed out of the curved surface portion 11a of the substrate 11, and it is possible to suppress the wrinkles of the retardation film 12 in the curved surface portion 11a.

Further, in the arrangement described above, it is preferable that the substrate 11 is tilted so that the tangent line of the curved surface portion 11a at the center point of the short diameter 11c of the substrate 11 is parallel to the retardation film 12. The means for tilting and arranging the substrate 11 is not particularly limited, but the substrate 11 can be tilted by, for example, installing a pedestal 32a having a tilted surface on the stage 32 and arranging the substrate 11 on the tilted surface. Alternatively, instead of tilting and arranging the substrate 11, the retardation film 12 may be tilted so that the tangent line at the center point of the short diameter 11c of the curved surface portion 11a is parallel to the retardation film 12. As a result, the retardation film 12 can be more evenly attached to the curved surface portion 11a. Therefore, it is possible to more surely prevent the wrinkled retardation film 12 from being attached to the curved surface portion 11a of the substrate 11 and to further suppress the wrinkles of the retardation film 12.

Note that, as a form of the retardation film 12, as illustrated in FIG. 3B, a protective film 14 may be provided on the surface of the retardation film 12 opposite to the substrate 11. In this case, the glass transition temperature of the protective film 14 is preferably lower than the glass transition temperature of the retardation film 12. In this way, the strength of the retardation film 12 is increased, and breakage or the like of the retardation film 12 hardly occurs when the retardation film 12 is attached to the substrate 11.

Further, the retardation film 12 is more expensive than general films. Therefore, the retardation film 12 may be one size larger than the area of the curved surface portion 11a of the substrate 11. More specifically, for example, the retardation film 12 may have an area of 1.5 to 2.5 times larger than the area of the curved surface portion 11a in the plan view viewed in the optical axis direction of the substrate 11. In this case, as illustrated in FIG. 3C, a support film 37 made of a member different from the retardation film 12 may be attached to the retardation film 12 in order to secure the size necessary for arranging the retardation film 12 between the first chamber 33 and the second chamber 34. At this time, in order to make the deflection of the film uniform when the film is heated, the glass transition temperature of the support film 37 is preferably about 20° C. lower than the glass transition temperature of the retardation film 12.

Further, as illustrated in FIG. 3D, the support film 37 may be attached only to the outer periphery of the retardation film 12. Note that the support film 37 can be peeled off from the retardation film 12 at an appropriate timing after the retardation film 12 is attached to the substrate 11.

Next, as illustrated in FIG. 3E, the opening of the first chamber 33 and the opening of the second chamber 34 are connected so that the retardation film 12 is interposed between them. Subsequently, the inside of the first chamber 33 and the inside of the second chamber 34 are vacuumed and the retardation film 12 is heated. Here, the method of heating the retardation film 12 includes, but is not limited to, a method using an infrared heater for directly heating the retardation film 12 and a method of heating the whole of the first chamber 33 and the second chamber 34 by a heater or the like. Note that, however, in the latter method, the substrate 11 is also heated. When the substrate 11 is heated, deformation of the substrate 11 due to heat is concerned, especially when the material of the substrate 11 is a plastic material. Therefore, when the substrate 11 is heated, it is important to make the pedestal 32a of the substrate 11 and the like have a heat insulating structure, and the temperature of the substrate 11 is preferably set to 120° C. or less regardless of the temperature of the retardation film 12.

Next, after the retardation film 12 is heated to a desired temperature, as illustrated in FIG. 3F, the position of the substrate 11 is raised until the curved surface portion 11a of the substrate 11 comes into contact with the adhesive layer 13 of the retardation film 12 by the stage 32 having a rise and fall function. Subsequently, only the atmosphere in the second chamber 34 is opened to the atmosphere to increase the internal pressure, and the retardation film 12 is pressurized and pressed onto the substrate 11 including the curved surface portion 11a by placing a high pressure gas in the second chamber 34 as needed. Thus, the retardation film 12 is attached to the curved surface of the curved surface portion 11a of the substrate 11. The retardation film 12 is stretched by being pressed onto the curved surface portion 11a and is provided on the curved surface of the curved surface portion 11a. Note that, if necessary, heating and pressurizing the retardation film 12 may be continued for a certain period of time.

Next, as illustrated in FIG. 3G, the heating and pressurizing of the retardation film 12 are stopped, the inside of the second chamber 34 is returned to the atmospheric pressure, and the inside of the first chamber 33 is also opened to the atmosphere.

Next, the retardation film 12 and the substrate 11 to which the retardation film 12 is attached are taken out from the first chamber 33 and the second chamber 34. Subsequently, as illustrated in FIG. 3H, the unnecessary retardation film 12 is cut off together with the adhesive layer 13 so that only the retardation film 12 attached to the curved surface portion 11a of the substrate 11 is left. The cutting-off method includes a method of cutting off the unnecessary retardation film 12 by applying a blade to the retardation film 12 along the outer periphery of the curved surface portion 11a, a method of cutting off the unnecessary retardation film 12 by applying a laser beam to the retardation film 12 along the outer periphery of the curved surface portion 11a, and the like. In this manner, the retardation optical element 10 in which the retardation film 12 is attached to the curved surface portion 11a of the substrate 11 is manufactured.

Note that the method of manufacturing the retardation optical element 10 is not limited to the manufacturing method illustrated in FIG. 3A to FIG. 3H, and the retardation optical element 10 can be manufactured by other manufacturing methods.

For example, as in Example 10 described later, after making the retardation film 12 attached to the curved surface portion 11a of a substrate 11, which has no distinction between the short diameter 11c and the long diameter 11d, the retardation optical element 10 according to the present embodiment can be manufactured by cutting off a predetermined end portion including the curved surface portion 11a of the substrate 11. In this case, first, the substrate is prepared by arranging the substrate 11 having the curved surface portion 11a with an axisymmetric planar shape, such as a regular circular shape or the like with no distinction between the short diameter 11c and the long diameter 11d in the plan view viewed in the optical axis direction of the substrate 11. Then, the retardation film 12 is attached to the curved surface of the curved surface portion 11a. Attaching the retardation film 12 can be performed in the same manner as in the manufacturing method described above. Next, an end portion of the substrate 11 including at least one side of the curved surface portion 11a is cut off together with the retardation film 12 attached to the end portion in a direction in which the angle with the slow axis 12a of the retardation film 12 becomes smaller than 45° in the plan view viewed in the optical axis direction of the substrate 11. The end portion of the substrate 11 including at least one side of the curved surface portion 11a is preferably cut off in a direction substantially parallel to the slow axis 12a. In this manner, the retardation optical element 10 according to the present embodiment can be manufactured.

As described above, according to the present embodiment, it is possible to suppress the wrinkles of the retardation film 12 attached to the curved surface of the curved surface portion 11a of the substrate 11.

Note that the retardation optical element 10 can be evaluated by, for example, measuring the surface shape. In such evaluation, the surface shape of the retardation optical element 10 can be evaluated by at least measuring along a line passing through the center of the circle of the arc of the curved surface portion 11a and parallel to the fast axis 12b, and measuring along a line passing through the center of the circle of the arc and parallel to the slow axis 12a. Specifically, when wrinkles having a height of 600 nm or more and a width of 50 μm or more are not identified by the measurement of the surface shape, the retardation optical element 10 can be evaluated as being good because there is no influence on the optical performance. Note that the surface shape can be measured, for example, by using a three-dimensional shape measuring instrument, Form Talysurf (manufactured by Taylor Hobson).

### EXAMPLES

Next, the retardation optical element 10 and the method of manufacturing the retardation optical element 10 according to the first embodiment will be specifically described with reference to examples.

### Example 1

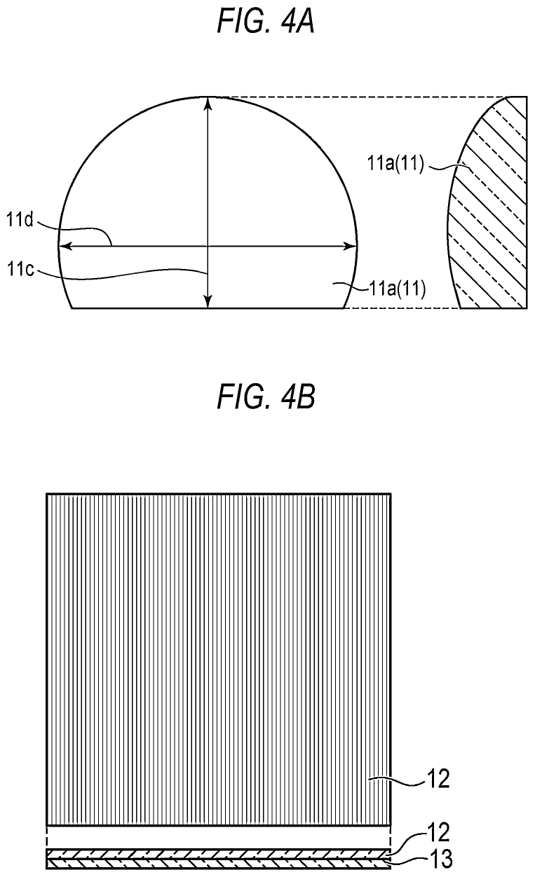

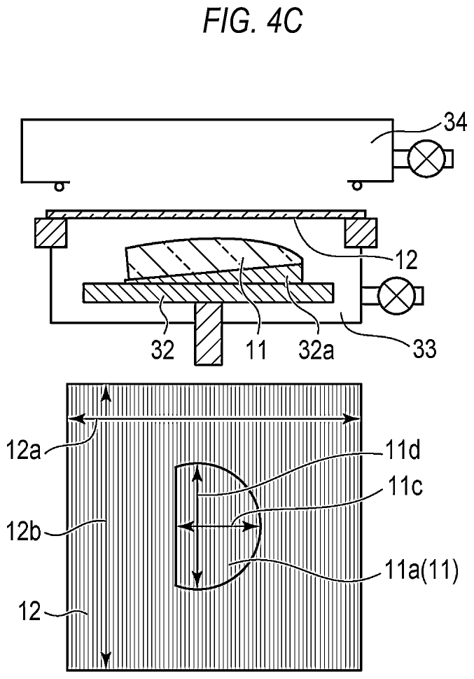

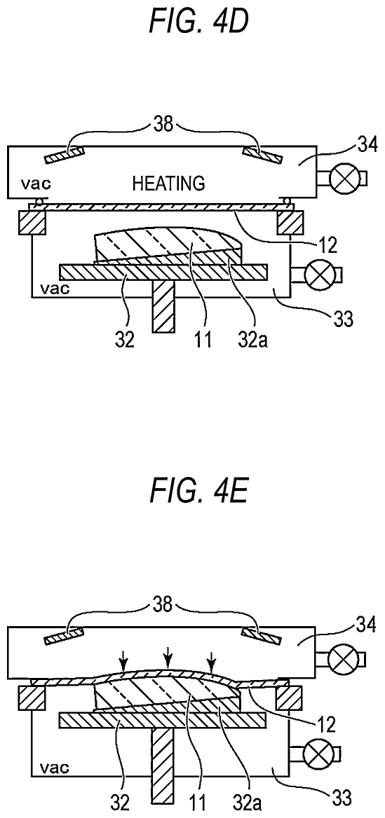

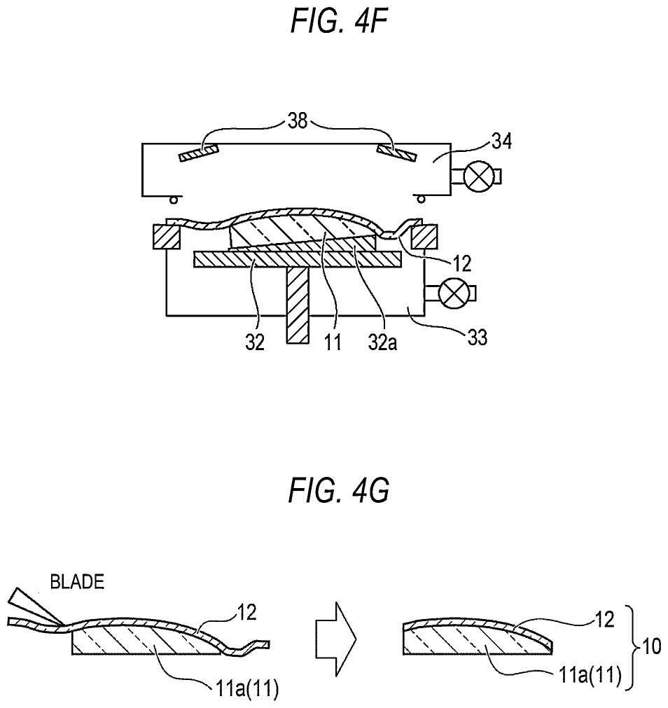

A retardation optical element 10 and a method of manufacturing the retardation optical element 10 of Example 1 will be described with reference to FIG. 4A to FIG. 4G.

First, in Example 1, the substrate 11 made of a plastic mainly composed of cyclic olefin copolymer (COC) molded by injection molding was prepared. FIG. 4A illustrates the substrate 11 prepared in Example 1, in which the left figure is a plan view illustrating the substrate 11 in a plan view viewed in the optical axis direction of the substrate 11, and the right figure is a cross-sectional view illustrating a cross section of the substrate 11 along the short diameter 11c. As illustrated in FIG. 4A, the substrate 11 was a convex lens, which had the length L1 of the short diameter 11c of 30 mm and the length L2 of the long diameter 11d of 50 mm in the curved surface portion 11a, and the half open angle θ of 20°, and did not have the peripheral edge portion 11b.

On the other hand, as the retardation film 12, a ¼ wavelength film was prepared. FIG. 4B illustrates the retardation film 12 prepared in Example 1, in which the upper figure is a plan view illustrating the retardation film 12 in a plan view viewed in a direction perpendicular to the film surface, and the lower figure is a cross-sectional view illustrating a cross section of the retardation film 12 along the slow axis 12a. As illustrated in FIG. 4B, the retardation film 12 was a ¼ wavelength film, which had a square planar shape of 160 mm×160 mm and the thickness of about 0.1 mm, and the adhesive layer 13 was provided on one surface of the film.

The upper figure of FIG. 4C and FIG. 4D to FIG. 4G are cross-sectional views illustrating the manufacturing method of the retardation optical element 10 of Example 1. The lower figure of FIG. 4C is a plan view illustrating the substrate 11 and the retardation film 12 in the process illustrated in the upper figure of FIG. 4C, and is a plan view viewed in a direction perpendicular to the film surface of the retardation film 12.

After preparing the substrate 11 and the retardation film 12 as described above, as illustrated in FIG. 4C, the substrate 11 was arranged in the first chamber 33, and the retardation film 12 was arranged between the first chamber 33 and the second chamber 34. At this time, the retardation film 12 was arranged so that the retardation film 12 faced the substrate 11 with the adhesive layer 13 facing the side of the substrate 11. The substrate 11 was arranged to be tilted so that the tangent line at the center point of the short diameter 11c is parallel to the retardation film 12. Further, as illustrated in FIG. 4C, the substrate 11 was arranged so that the short diameter 11c of the curved surface portion 11a of the substrate 11 and the slow axis 12a of the retardation film 12 were parallel to each other (the angle q was) 0°.

Next, as illustrated in FIG. 4D, the inside of the first chamber 33 and the inside of the second chamber 34 were vacuumed, and the retardation film 12 arranged between the first chamber 33 and the second chamber 34 was heated by an infrared heater 38.

Next, after the retardation film 12 was heated to 100° C., the position of the substrate 11 was raised by the stage 32 until the curved surface portion 11a of the substrate 11 came into contact with the adhesive layer 13 of the retardation film 12, as illustrated in FIG. 4E. Subsequently, only the second chamber 34 was opened to the atmosphere. Thereafter, compressed air was introduced into the second chamber 34 to raise the pressure inside the second chamber 34 to 0.3 MPa, and the retardation film 12 was pressurized and pressed onto the substrate 11 for 10 seconds.

Next, as illustrated in FIG. 4F, after the heating and pressurization of the retardation film 12 were stopped and the second chamber 34 was returned to the atmospheric pressure, the first chamber 33 was also opened to the atmosphere.

Next, as illustrated in FIG. 4G, the retardation film 12 and the substrate 11 to which the retardation film 12 was attached were removed from the first chamber 33 and the second chamber 34. Subsequently, the unnecessary retardation film 12 was cut off together with the adhesive layer 13 by applying a blade to the retardation film 12 along the outer periphery of the curved surface portion 11a so as to leave only the retardation film 12 of the curved surface portion 11a of the substrate 11. Thus, the retardation optical element 10 in which the retardation film 12 was attached to the curved surface portion 11a of the substrate 11 was manufactured.

As an evaluation of the retardation optical element 10 of Example 1, an evaluation was performed by measuring the surface shape using a three-dimensional shape measuring instrument Form Talysurf. As a result, wrinkles having a height of 600 nm or more and a width of 50 μm or more were not identified, and the optical performance was not affected. Therefore, the retardation optical element 10 of Example 1 was evaluated to be good as shown in Table 1.

### Example 2

In Example 2, the shape of the substrate 11 of Example 1 was changed, and in the shape of the substrate 11 illustrated in FIG. 4A, the length L1 of the short diameter 11c was set to 35 mm and the length L2 of the long diameter 11d was set to 50 mm in the curved surface portion 11a, and the curved surface portion 11a was set to a convex lens having the half open angle θ of 10°. In Example 2, the retardation optical element 10 was manufactured in the same manner as in Example 1 except that the shape of the substrate 11 was changed.

When the retardation optical element 10 of Example 2 was evaluated in the same manner as in Example 1, wrinkles having a height of 600 nm or more and a width of 50 μm or more were not identified, and the optical performance was not affected. Therefore, the retardation optical element 10 of Example 2 was evaluated to be good as shown in Table 1.

### Example 3

In Example 3, the shape of the substrate 11 of Example 1 was changed, and in the shape of the substrate 11 illustrated in FIG. 4A, the length L1 of the short diameter 11c was set to 48 mm and the length L2 of the long diameter 11d was set to 50 mm in the curved surface portion 11a, and the curved surface portion 11a was set to a convex lens having the half open angle θ of 5°. In Example 3, the retardation optical element 10 was manufactured in the same manner as in Example 1 except that the shape of the substrate 11 was changed.

When the retardation optical element 10 of Example 3 was evaluated in the same manner as in Example 1, wrinkles having a height of 600 nm or more and a width of 50 μm or more were not confirmed, and the optical performance was not affected. Therefore, the retardation optical element 10 of Example 3 was evaluated to be good as shown in Table 1.

### Example 4

In Example 4, the shape of the substrate 11 of Example 1 was changed, and in the shape of the substrate 11 illustrated in FIG. 4A, the length L1 of the short diameter 11c was set to 35 mm and the length L2 of the long diameter 11d was set to 50 mm in the curved surface portion 11a, and the curved surface portion 11a was set to be a convex lens having the half open angle θ of 30°. In Example 4, the retardation optical element 10 was manufactured in the same manner as in Example 1 except that the shape of the substrate 11 was changed.

When the retardation optical element 10 of Example 4 was evaluated in the same manner as in Example 1, wrinkles having a height of 600 nm or more and a width of 50 μm or more were not identified, and the optical performance was not affected. Therefore, the retardation optical element 10 of Example 4 was evaluated to be good as shown in Table 1.

### Example 5

In Example 5, the shape of the substrate 11 of Example 1 was changed, and in the shape of the substrate 11 illustrated in FIG. 4A, the length L1 of the short diameter 11c was set to 40 mm and the length L2 of the long diameter 11d was set to 50 mm in the curved surface portion 11a, and the curved surface portion 11a was set to be a convex lens having the half open angle θ of 20°. In Example 5, the retardation optical element 10 was manufactured in the same manner as in Example 1 except that the shape of the substrate 11 was changed.

When the retardation optical element 10 of Example 5 was evaluated in the same manner as in Example 1, wrinkles having a height of 600 nm or more and a width of 50 μm or more were not identified, and the optical performance was not affected. Therefore, the retardation optical element 10 of Example 5 was evaluated to be good as shown in Table 1.

### Example 6

In Example 6, the shape of the substrate 11 of Example 1 was changed, and in the shape of the substrate 11 illustrated in FIG. 4A, the length L1 of the short diameter 11c was set to 40 mm and the length L2 of the long diameter 11d was set to 50 mm in the curved surface portion 11a, and the curved surface portion 11a was set to a convex lens having the half open angle θ of 20°. In example 6, the retardation optical element 10 was manufactured in the same manner as in Example 1 except that the shape of the substrate 11 was changed.

When the retardation optical element 10 of Example 6 was evaluated in the same manner as in Example 1, wrinkles having a height of 600 nm or more and a width of 50 μm or more were not confirmed, and the optical performance was not affected. Therefore, the retardation optical element 10 of Example 6 was evaluated to be good as shown in Table 1.

### Example 7

In Example 7, the shape of the substrate 11 of Example 1 was changed, and in the shape of the substrate 11 illustrated in FIG. 4A, the length L1 of the short diameter 11c was set to 30 mm and the length L2 of the long diameter 11d was set to 50 mm in the curved surface portion 11a, and the curved surface portion 11a was set to be a concave lens having the half open angle θ of 20°. In Example 7, the retardation optical element 10 was manufactured in the same manner as in Example 1 except that the shape of the substrate 11 was changed.

When the retardation optical element 10 of Example 7 was evaluated in the same manner as in Example 1, wrinkles having a height of 600 nm or more and a width of 50 μm or more were not identified, and the optical performance was not affected. Therefore, the retardation optical element 10 of Example 7 was evaluated to be good as shown in Table 1.

### Example 8

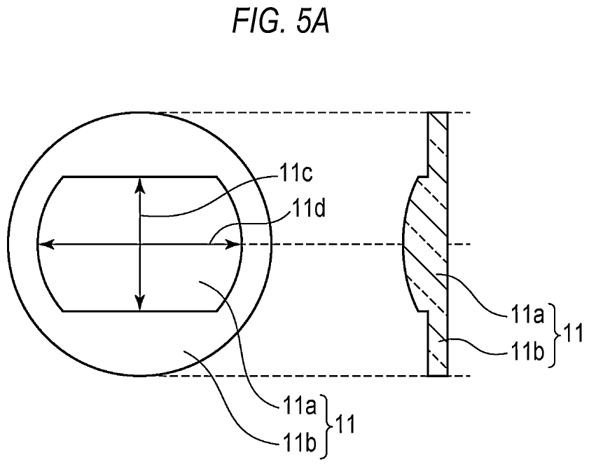

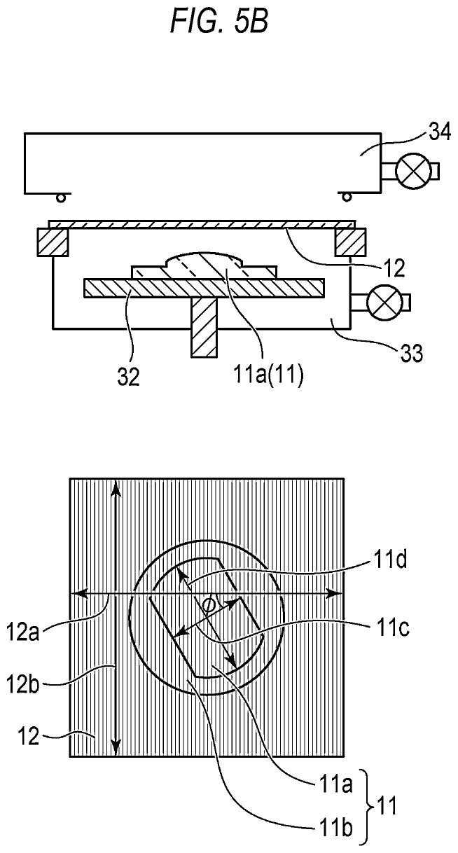

In Example 8, the substrate 11 having the shape illustrated in FIG. 5A was prepared. FIG. 5A illustrates the substrate 11 prepared in Example 8, in which the left figure is a plan view illustrating the substrate 11 in a plan view viewed in the optical axis direction of the substrate 11, and the right figure is a cross-sectional view illustrating a cross section of the substrate 11 along the short diameter 11c. As illustrated in FIG. 5A, in the plan view of the substrate 11, the curved surface portion 11a had two mutually opposed arcs and two mutually opposed parallel sides connecting two mutually opposed ends of these two arcs, respectively, and had the peripheral edge portion 11b adjacent to the curved surface portion 11a. In Example 8, the length L1 of the short diameter 11c was set to 30 mm and the length L2 of the long diameter 11d was set to 40 mm in the curved surface portion 11a, and the curved surface portion 11a was set to a convex lens having the half open angle θ of 20°. As the peripheral edge portion 11b, the flat peripheral edge portion 11b having an outer diameter of 46 mm was provided. In Example 8, the retardation optical element 10 was manufactured in the same manner as in Example 1 except that the shape of the substrate 11 was changed.

When the retardation optical element 10 of Example 8 was evaluated in the same manner as in Example 1, wrinkles having a height of 600 nm or more and a width of 50 μm or more were not identified, and the optical performance was not affected. Therefore, the retardation optical element 10 of Example 8 was evaluated to be good as shown in Table 1.

### Example 9

In Example 9, the shape of the substrate 11 of Example 8 was changed, and in the shape of the substrate 11 illustrated in FIG. 5A, the length L1 of the short diameter 11c was set to 30 mm and the length L2 of the long diameter 11d was set to 50 mm in the curved surface portion 11a, and the curved surface portion 11a was set to a convex lens having the half open angle θ of 20°. As the peripheral edge portion 11b, the flat peripheral edge portion 11b having an outer diameter of 56 mm was provided. The upper figure of FIG. 5B is a cross-sectional view illustrating the manufacturing method of the retardation optical element 10 of Example 9. The lower figure of FIG. 5B is a plan view illustrating the substrate 11 and the retardation film 12 in the process illustrated in the upper figure of FIG. 5B, and is a plan view viewed in a direction perpendicular to the film surface of the retardation film 12. In Example 9, as illustrated in FIG. 5B, the substrate 11 was arranged in the first chamber 33, and the retardation film 12 was arranged between the first chamber 33 and the second chamber 34. At this time, the retardation film 12 was arranged so that the retardation film 12 faced the substrate 11 with the adhesive layer 13 facing the side of the substrate 11. The substrate 11 was arranged on the stage 32 without being tilted without using the pedestal 32a. Further, the substrate 11 is arranged so that the angle o formed by the short diameter 11c of the curved surface portion 11a and the slow axis 12a of the retardation film 12 was 30°. In Example 9, the retardation optical element 10 was manufactured in the same manner as in Example 8 except that the shape of the substrate 11 was changed and the angle o formed by the short diameter 11c of the curved surface portion 11a and the slow axis 12a of the retardation film 12 was 30°.

When the retardation optical element 10 of Example 9 was evaluated in the same manner as in Example 1, wrinkles having a height of 600 nm or more and a width of 50 μm or more were not identified, and the optical performance was not affected. Therefore, the retardation optical element 10 of Example 9 was evaluated to be good as shown in Table 1.

### Example 10

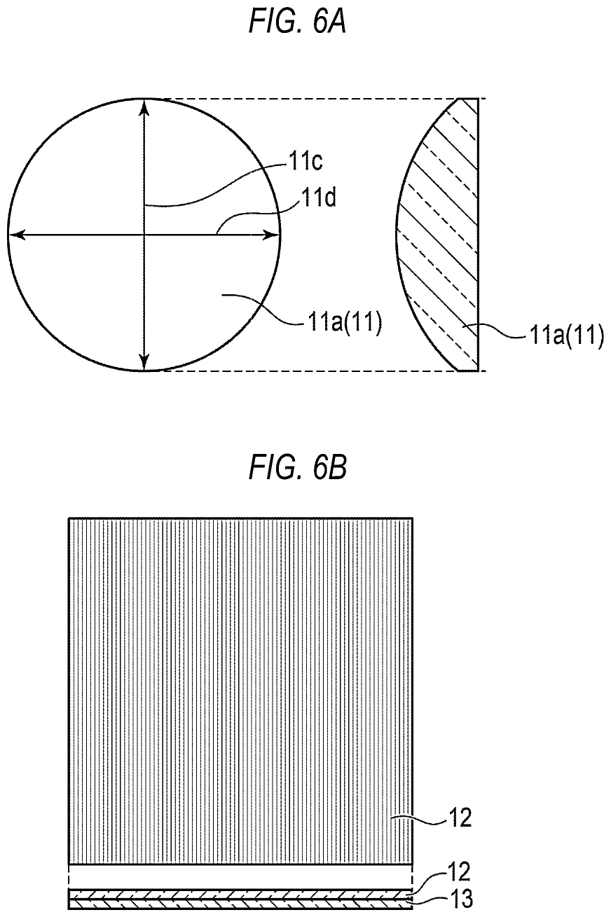

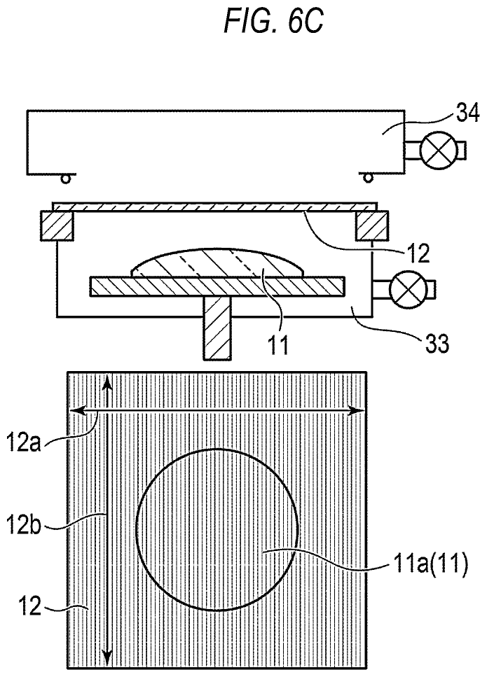

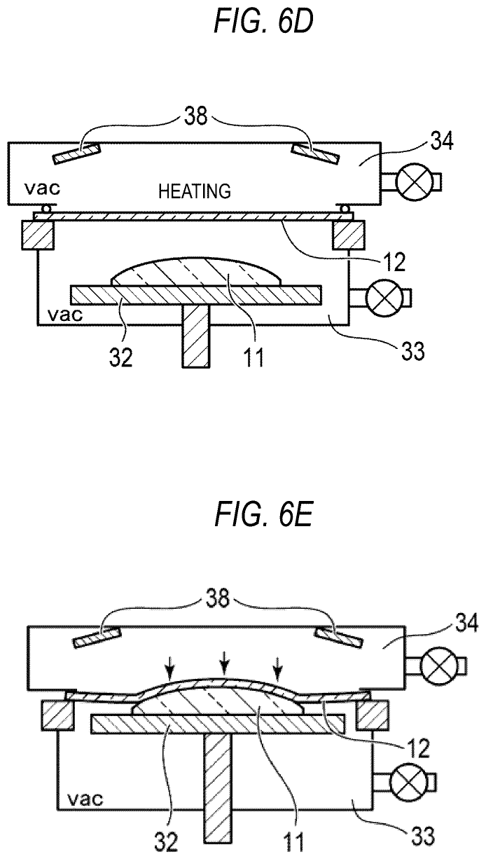

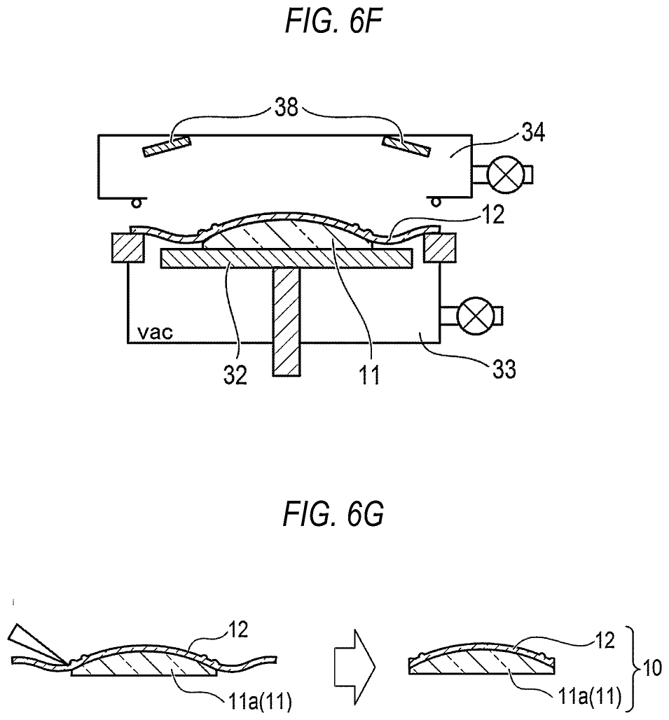

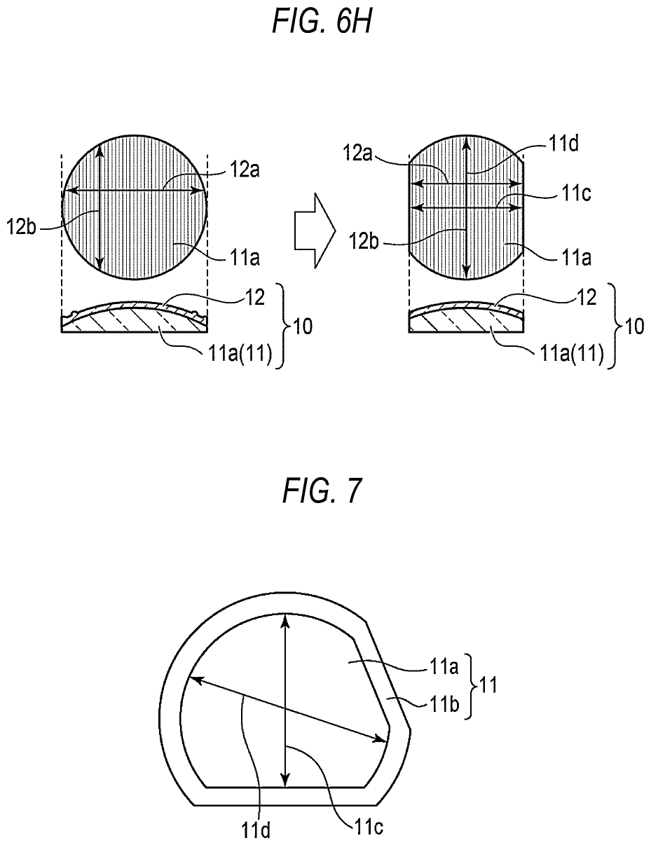

In Example 10, the substrate 11 having the shape illustrated in FIG. 6A was prepared. FIG. 6A shows the substrate 11 prepared in Example 10, in which the left figure is a plan view illustrating the substrate 11 in a plan view viewed in the optical axis direction of the substrate 11, and the right figure is a cross-sectional view illustrating a cross section of the substrate 11 along the short diameter 11c. As illustrated in FIG. 6A, the substrate 11 had a shape, in which the curved surface portion 11a was a convex lens having a circular shape with the length L1 of the short diameter 11c of 50 mm and the length L2 of the long diameter 11d of 50 mm in the plan view, and the half open angle θ of 20°, and the peripheral edge portion 11b was not provided.

On the other hand, as the retardation film 12, a ¼ wavelength film similar to that of Example 1 was prepared as illustrated in FIG. 6B. FIG. 6B illustrates the retardation film 12 prepared in Example 10, in which the upper figure is a plan view illustrating the retardation film 12 in a plan view viewed in a direction perpendicular to the film surface, and the lower figure is a cross-sectional view illustrating a cross section of the retardation film 12 along the slow axis 12a.

The upper figure of FIG. 6C and FIG. 6D to FIG. 6G are cross-sectional views illustrating the manufacturing method of the retardation optical element 10 of Example 10. The lower figure of FIG. 6C is a plan view illustrating the substrate 11 and the retardation film 12 in the process illustrated in the upper figure of FIG. 6C, and is a plan view viewed in a direction perpendicular to the film surface of the retardation film 12. FIG. 6H is a plan view illustrating the manufacturing method of the retardation optical element 10 of Example 10.

After preparing the substrate 11 and the retardation film 12 as described above, as illustrated in FIG. 6C, the substrate 11 was arranged in the first chamber 33, and the retardation film 12 was arranged between the first chamber 33 and the second chamber 34. the retardation film 12 was arranged so that the retardation film 12 faced the substrate 11 with the adhesive layer 13 facing the side of the substrate 11. The substrate 11 was arranged on the stage 32 without being tilted without using the pedestal 32a. The direction of the slow axis 12a of the retardation film 12 was not particularly specified.

Next, as illustrated in FIG. 6D, the inside of the first chamber 33 and the inside of the second chamber 34 were vacuumed, and the retardation film 12 arranged between the first chamber 33 and the second chamber 34 was heated by the infrared heater 38.

Next, after the retardation film 12 was heated to 100° C., the position of the substrate 11 was raised by the stage 32 until the curved surface portion 11a of the substrate 11 came into contact with the adhesive layer 13 of the retardation film 12, as illustrated in FIG. 6E. Subsequently, only the second chamber 34 was opened to the atmosphere. Thereafter, compressed air was introduced into the second chamber 34 to raise the pressure inside the second chamber 34 to 0.3 MPa, and the retardation film 12 was pressurized and pressed onto the substrate 11 for 10 seconds.

Next, as illustrated in FIG. 6F, after the heating and pressurization of the retardation film 12 were stopped and after the second chamber 34 was returned to the atmospheric pressure, the first chamber 33 was also opened to the atmosphere.

Next, as illustrated in FIG. 6G, the retardation film 12 and the substrate 11 to which the retardation film 12 was attached were removed from the first chamber 33 and the second chamber 34. Subsequently, the unnecessary retardation film 12 was cut off together with the adhesive layer 13 by applying a blade to the retardation film 12 along the outer periphery of the curved surface portion 11a so as to leave only the retardation film 12 of the curved surface portion 11a of the substrate 11.

When the surface shape of the retardation optical element 10 manufactured as described above was measured in the same manner as in Example 1, a plurality of wrinkles having a height of 600 nm or more and a width of 50 μm or more were generated in the outer periphery portion of the curved surface portion 11a with a width of 5 mm from the outer periphery. All the wrinkles generated were generated in the outer periphery portion of the retardation film 12 in a direction parallel to the slow axis 12a. Therefore, in Example 10, as illustrated in FIG. 6H, in the retardation optical element 10 described above, end portions of the curved surface portion 11a on both sides in a direction parallel to the slow axis 12a were cut off by 5 mm. Thus, in Example 10, the retardation optical element 10 was manufactured by cutting off the portions with the wrinkles generated after the retardation film 12 was attached to the curved surface portion 11a of the substrate 11. When the retardation optical element 10 of Example 10 was evaluated in the same way as in Example 1, wrinkles having a height of 600 nm or more and a width of 50 μm or more were not identified, and the optical performance was not affected. Therefore, the retardation optical element 10 of Example 10 was evaluated to be good as shown in Table 1.

### Example 11

In Example 11, the substrate illustrated in FIG. 7 was prepared. FIG. 7 is a plan view illustrating the substrate 11 prepared in Example 11 and illustrating the substrate 11 in a plan view viewed in the optical axis direction of the substrate 11. As illustrated in FIG. 7, in the plan view, the substrate 11 had a shape, in which the curved surface portion 11a had two sides facing different directions from each other and two arcs connecting two adjacent sets of ends of the two sides, respectively, and had the peripheral edge portion 11b adjacent to the curved surface portion 11a. The two arcs were parts of the circumference of the same circle. In Example 11, the length L1 of the short diameter 11c was set to 40 mm and the length L2 of the long diameter 11d was set to 60 mm in of the curved surface portion 11a, and the curved surface portion 11a is a convex lens having the half open angle θ of 20°. The flat peripheral edge portion 11b having a width of 2 mm was provided as the peripheral edge portion 11b. In Example 11, the retardation optical element 10 was manufactured in the same manner as in Example 1 except that the shape of the substrate 11 was changed.

When the retardation optical element 10 of Example 11 was evaluated in the same manner as in Example 1, wrinkles having a height of 600 nm or more and a width of 50 μm or more were not identified, and the optical performance was not affected. Therefore, the retardation optical element 10 of Example 11 was evaluated to be good as shown in Table 1.

### Comparative Example 1

In Comparative Example 1, the substrate 11 having the shape illustrated in FIG. 6A was prepared. As illustrated in FIG. 6A, the substrate 11 had a shape, in which the curved surface portion 11a was a convex lens having the length L1 of the short diameter 11c of 50 mm and the length L2 of the long diameter 11d of 50 mm in the plan view, and the half open angle θ of 20°, and the peripheral edge portion 11b was not provided. In Comparative Example 1, the retardation optical element 10 was manufactured in the same manner as in Example 1 except that the shape of the substrate 11 was changed and the direction of the slow axis 12a was not specifically specified when the retardation film 12 was arranged.

When the retardation optical element 10 of Comparative Example 1 was evaluated in the same manner as in Example 1, a plurality of wrinkles having a height of 600 nm or more and a width of 50 μm or more were identified, which affected the optical performance. Therefore, the retardation optical element 10 of Comparative Example 1 was evaluated to be defective as shown in Table 1.

### Comparative Example 2

In Comparative Example 2, the substrate 11 having the shape illustrated in FIG. 5A was prepared. As illustrated in FIG. 5A, the substrate 11 had a shape, in which the curved surface portion 11a was a convex lens having the length L1 of the short diameter 11c of 40 mm and the length L2 of the long diameter 11d of 50 mm in the plan view, and the half open angle θ of 20°, and the flat peripheral edge portion 11b having an outer diameter of 56 mm was provided. In Comparative Example 2, as illustrated in FIG. 5B, the substrate 11 was arranged in the first chamber 33, and a retardation film 12 was arranged between the first chamber 33 and the second chamber 34. At this time, the retardation film 12 was arranged so that the retardation film 12 faced the substrate with the adhesive layer 13 facing the side of the substrate 11. The substrate 11 was arranged on the stage 32 without being tilted without using the pedestal 32a. Further, the substrate 11 was arranged so that the angle o formed by the short diameter 11c of the curved surface portion 11a and the slow axis 12a of the retardation film 12 was set to 45°. In Comparative Example 2, the retardation optical element 10 was manufactured in the same manner as in Example 8 except that the shape of the substrate 11 was changed and the angle o formed between the short diameter 11c of the curved surface portion 11a and the slow axis 12a of the retardation film 12 was set to 45°.

When the retardation optical element 10 of Comparative Example 2 was evaluated in the same manner as in Example 1, a plurality of wrinkles having a height of 600 nm or more and a width of 50 μm or more were identified, which affected the optical performance. Therefore, the retardation optical element 10 of Comparative Example 2 was evaluated to be defective as shown in Table 1.

The evaluation of the retardation optical elements 10 of the examples and the comparative examples described above together with details such as the shape of the substrate 11 is shown in Table 1 below.

TABLE 1

| | | | | Short Diameter | Long Diameter | | | | |
|---|---|---|---|---|---|---|---|---|---|
| | Subtrate | Shape of Curved | Half Open | Length L1 | Length L2 | | | | |
| | Shape | Surface Portion | Angle θ | (mm) | (mm) | L1/L2 | Angle φ | (L1/cosφ)/L2 | Evaluation |
| Example 1 | FIG. 4A | Convex | 20° | 30 | 50 | 0.6 | 0° | 0.6 | Good |
| Example 2 | FIG. 4A | Convex | 10° | 35 | 50 | 0.7 | 0° | 0.7 | Good |
| Example 3 | FIG. 4A | Convex | 5° | 48 | 50 | 0.96 | 0° | 0.96 | Good |
| Example 4 | FIG. 4A | Convex | 30° | 35 | 50 | 0.7 | 0° | 0.7 | Good |
| Example 5 | FIG. 4A | Convex | 20° | 40 | 50 | 0.8 | 0° | 0.8 | Good |
| Example 6 | FIG. 4A | Convex | 20° | 10 | 50 | 0.2 | 0° | 0.2 | Good |
| Example 7 | FIG. 4A | Concave | 20° | 30 | 50 | 0.6 | 0° | 0.6 | Good |
| Example 8 | FIG. 5A | Convex | 20° | 30 | 40 | 0.75 | 0° | 0.75 | Good |
| Example 9 | FIG. 5A | Convex | 20° | 30 | 50 | 0.6 | 30° | 0.69 | Good |
| Example 10 | FIG. 6A | Convex | 20° | 40 | 50 | 0.8 | 0° | 0.8 | Good |
| | Cut off | | | | | | | | |
| Example 11 | FIG. 7 | Convex | 20° | 40 | 60 | 0.67 | 0° | 0.67 | Good |
| Comparative | FIG. 4A | Convex | 20° | 50 | 50 | 1 | 0° | 1 | Defective |
| Example 1 | | | | | | | | | |
| Comparative | FIG. 5A | Convex | 20° | 40 | 50 | 0.8 | 45° | 1.13 | Defective |
| Example 2 | | | | | | | | | |

### Second Embodiment

The retardation optical element 10 according to the first embodiment can be applied to various apparatuses such as optical apparatuses, display apparatuses, imaging apparatuses, and the like. In the present embodiment, an optical apparatus and a display apparatus will be described as specific application examples of the retardation optical element 10 according to the first embodiment.

### (Optical Apparatus)

Specific application examples of the retardation optical element 10 according to the first embodiment include lenses that constitute optical apparatuses (imaging optical systems) for cameras and video cameras, lenses constituting optical apparatuses (projection optical systems) for liquid crystal projectors, and the like. The retardation optical element 10 according to the first embodiment can also be used as a pickup lens such as a DVD recorder. Each of these optical systems includes at least one lens arranged in a housing, and the retardation optical element 10 according to the first embodiment can be used for the at least one of the lenses.

### (Display Apparatus)

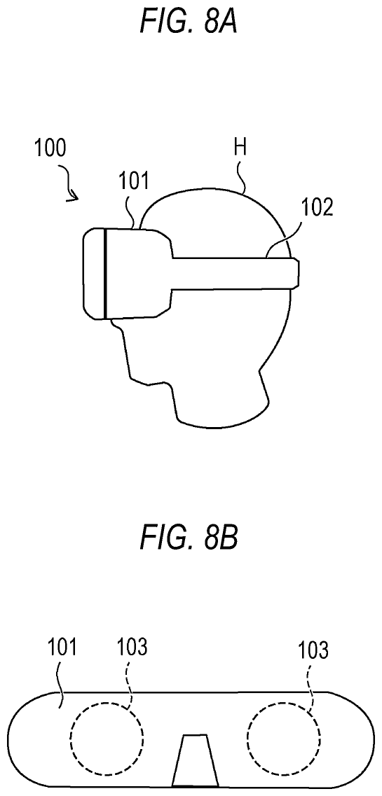

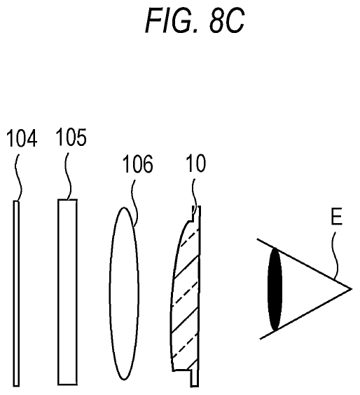

FIG. 8A to FIG. 8C are schematic diagrams illustrating a configuration of a head-mounted display (HMD) 100, which is an example of a preferred embodiment of a display apparatus using the retardation optical element 10 according to the first embodiment. FIG. 8A is a side view illustrating the HMD 100. FIG. 8B is a front view illustrating the HMD 100. FIG. 8C is a schematic diagram illustrating the optical system of the HMD 100.

As illustrated in FIG. 8A and FIG. 8B, the HMD 100 includes a housing 101, a mounting tool 102, and display units 103 for the left eye and the right eye. Each of the display units 103 is provided in the housing 101. The HMD 100 is mounted on the head H of a user by the mounting tool 102 so that the display units 103 for the left eye and the right eye are positioned corresponding to the left eye and the right eye of the user, respectively.

As illustrated in FIG. 8C, each of the display units 103 includes a display panel 104, optical systems 105 and 106, and the retardation optical element 10 according to the first embodiment. The display panel 104 is a display unit of an organic electroluminescence (EL) panel, a liquid crystal panel, or the like, and displays a corresponding image for the left eye or the right eye. The optical systems 105 and 106 are used to form an image of an image light emitted from the display panel 104 at the position of the eye of the user. Depending on the design of the HMD 100, the optical systems 105 and 106 may include a transmission optical element such as a convex lens or a concave lens, a reflection optical element such as a concave mirror, an optical path changing element such as a mirror, a half mirror, or a polarization beam splitter (PBS), and the like. The retardation optical element 10 is provided to be positioned between the optical systems 105 and 106 and the eye E. The retardation optical element 10, together with the optical systems 105 and 106, constitutes an optical system for guiding image light, which is light emitted from the display panel 104, to the eye E of the user, and functions as at least one of the optical elements or lenses in the optical system.

Note that the display apparatus has been described using HMD here, but the retardation optical element 10 can also be used as a projector or the like.

According to the present invention, it is possible to suppress wrinkles of the retardation film attached to the curved surface in the retardation optical element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-193015, filed Nov. 13, 2023, which is hereby incorporated by reference herein in its entirety.

What is claimed is:

1. A retardation optical element comprising:
a substrate including a curved surface portion having a first width and a second width longer than the first width in a plan view in an optical axis direction; and
a retardation film having a fast axis and a slow axis and attached to a curved surface of the curved surface portion,
wherein an angle formed by the slow axis and the first width is smaller than 45° in the plan view.

2. The retardation optical element according to claim 1, wherein the retardation film is stretched and provided on the curved surface.

3. The retardation optical element according to claim 1, wherein, in the plan view, the curved surface portion has a shape surrounded by an arc and a straight line connecting adjacent ends of the arc, and
wherein the first width is the shortest diameter among diameters passing through a center point of a circle of the arc of the curved surface portion in the plan view.

4. The retardation optical element according to claim 1, wherein, in the plan view, the curved surface portion has a shape surrounded by a plurality of arcs and lines connecting adjacent ends of the arcs, and
wherein the first width is the shortest diameter among diameters passing through a center of gravity of the shape of the curved surface portion in the plan view.

5. The retardation optical element according to claim 1, wherein, when a half open angle of the curved surface is θ, θ satisfies 0°<θ≤30°.

6. The retardation optical element according to claim 5, wherein, when an angle formed by the first width and the slow axis is φ, a length of the first width is L1, and a length of the second width is L2, L1 and L2 satisfy the following expression with respect to a range of 5°<<30°.
$$0.2 \leq ( L 1 / cos φ ) / L 2 \leq - 0.01 \times θ + 1.$$

7. The retardation optical element according to claim 1, wherein the angle formed by the slow axis and the first width is within 30° in the plan view.

8. The retardation optical element according to claim 1, wherein the slow axis and the first width are substantially parallel to each other in the plan view.

9. The retardation optical element according to claim 1, wherein the substrate includes a peripheral edge portion provided at a peripheral edge of the curved surface portion.

10. The retardation optical element according to claim 1, wherein the retardation film is attached to the curved surface by an adhesive layer.

11. The retardation optical element according to claim 1, wherein the retardation film is a ½ wavelength film or a ¼ wavelength film.

12. A method of manufacturing a retardation optical element, the method comprising:
arranging a substrate including a curved surface portion having a first width and a second width longer than the first width in a plan view viewed in an optical axis direction; and
attaching a retardation film having a fast axis and a slow axis to a curved surface of the curved surface portion, while arranging the retardation film so that the angle formed by the slow axis and the first width is smaller than 45° in the plan view.

13. The method of manufacturing a retardation optical element according to claim 12, wherein the attaching attaches the retardation film to the curved surface by pressing the retardation film onto the substrate.

14. The method of manufacturing a retardation optical element according to claim 12, wherein the attaching arranges the retardation film having the fast axis and the slow axis so that the angle formed by the slow axis and the first width is within 30° in the plan view.

15. The method of manufacturing a retardation optical element according to claim 12, wherein the arranging arranges the substrate so that a tangent line of the curved surface portion at a center point of the first width is parallel to the retardation film.

16. The method of manufacturing a retardation optical element according to claim 12, wherein the attaching attaches the retardation film to the curved surface after heating the retardation film.

17. A method of manufacturing a retardation optical element, the method comprising:
arranging a substrate including a curved surface portion;
attaching a retardation film having a fast axis and a slow axis to a curved surface of the curved surface portion; and
cutting off an end portion of the substrate including at least one side of the curved surface portion in a direction in which an angle with the slow axis becomes smaller than 45° in a plan view viewed in an optical axis direction.

18. An optical apparatus comprising a housing and an optical system including at least one optical element arranged in the housing,
wherein the at least one optical element is the retardation optical element according to claim 1.

19. A display apparatus comprising a housing, an optical system including at least one optical element arranged in the housing, and display unit that emits light guided by the optical system,
wherein the at least one optical element is the retardation optical element according to claim 1.
